(19) United States
(12) Patent Application Publication
(10) Pub. No.: US 2006/0028521 A1
(43) Pub. Date: Feb. 9, 2006

(54) Ink composition and ink-jet printing method using the same for improving ink-jet print quality

(75) Inventor: Moshe Frenkel, Jerusalem (IL)

Correspondence Address: MOSHE FRENKEL;PERFECTA JET LIMITED, 19 ALFASI STREET, JERUSALEM, 91040, IL

(73) Assignee: PERFECTA JET LIMITED

(21) Appl. No.: 11/193,203

(22) Filed: Aug. 1, 2005

Related U.S. Application Data
(60) Provisional application No. 60/598,851, filed on Aug. 5, 2004.

(51) Int. Cl. C09D 11/00; G01D 11/00; B41J 2/17

(52) U.S. Cl. 347/100; 106/31.27; 106/31.6; 106/31.43; 106/31.75; 106/31.58; 106/31.86; 106/31.87; 347/95

(57) ABSTRACT

An ink-jet recording method comprising the step of ejecting a water-based inkjet ink onto a substrate printed material coated with a fixation layer causing a rapid reaction between the ink composition and the fixation layer on top of the substrate. The fixation layer on top of the substrate contains an aqueous soluble salt and as soon as the ink droplet hits the fixation layer and will precipitate a non-soluble salt to produce an image having an excellent print quality with virtually no ink bleeding, strike through, feathering and optical density loss. The ink composition comprises one or more aqueous soluble salts together with a colorant, water soluble organic solvent, wetting agent and optionally anionic polymer resin.

### RELATED U.S. APPLICATION DATA

Provisional Application No. 60/598,851, filed on Aug. 5, 2004

### REFERENCES CITED

U.S. Patent Documents

| | | |
|---|---|---|
| 6,040,060 | March 2000 | Missel et al |
| 6,261,353 | July 2001 | Doi et al |
| 6,341,854 | January 2002 | Takemoto |
| 6,352,341 | March 2002 | Kovacs et al |
| 6,391,947 | May 2002 | Noguchi et al |
| 6,419,733 | July 2002 | Sano et al |
| 6,485,138 | November 2002 | Kubota et al |
| 6,534,156 | March 2003 | Baker et al |
| 6,534,157 | March 2003 | Baker et al |
| 6,554,418 | April 2003 | Laurence et al |
| 6,607,266 | August 2003 | Katsuragi et al |
| 6,740,689 | May 2004 | Lee et al |
| 6,827,434 | December 2004 | Katsuragi et al |
| 6,863,391 | March 2005 | Tomioka et al |
| 6,908,187 | June 2005 | Yoshizawa et al |

U.S. Patent Application Publication Document

| | | |
|---|---|---|
| 2004/0119800 | June 2004 | Takada et al |

Foreign Patent Documents

| | | | |
|---|---|---|---|
| EP | 0 829 374 | A2 | March 1998 |
| EP | 0 885 744 | A1 | December 1998 |
| EP | 0 892 024 | B1 | January 1999 |

Other Publications
H. P. Le, Progress and Trends in Ink-Jet Printing Technology,” Journal of Imaging Science & Tech., 42, (1), 1998.

### 1. FIELD OF THE INVENTION

The present invention provides a two component printing system used in an ink-jet recording method that ejects ink droplets onto a fixation layer to produce an insoluble precipitate. More specifically, the invention relates to an aqueous ink containing a water soluble salt which is ejected as droplets onto fixation layer containing a water soluble salt situated on top of a substrate. This method virtually eliminates the undesirous effects of feathering, bleeding, strike-through and optical density loss.

### 2. DESCRIPTION OF PRIOR ART

Ink-jet is defined as a non-impact dot-matrix printing technology in which droplets of ink are ejected through fine nozzles, to record letters, images or figures onto the surface of a recording media such as paper, cloth or film. The printing process can achieve printing of high resolution and high quality images at high speed. The use of ink-jet printing systems has increased dramatically during the past decade. This growth may be attributed to substantial improvements in print resolution, decrease in the size of the ink droplets that are ejected and overall print quality coupled with appreciable reduction in cost. Today's ink-jet printers offer acceptable print quality for many commercial, business, and household applications at costs fully an order of magnitude lower than comparable products that were on the market just a few years ago. Notwithstanding their recent success, intensive research and development continue toward improving ink-jet print quality, while lowering costs to the consumer.

Two different types of ink are used in inkjet printers: one is slow and penetrating and takes about ten seconds to dry, and the other is a fast-drying ink. The former is generally better suited to straightforward monochrome printing, while the latter is used for color. With color printing, because different inks are mixed, they need to dry as rapidly as possible to avoid blurring. If slow-drying ink is used for color printing, the colors tend to bleed into one another before they have dried. The water-based ink used in inkjet technology possess other problems. The results from some of the earlier inkjet printers were prone to smudging and running, but over the past few years there have been considerable improvements in ink chemistry. Solvent-based ink is not a solution to the home and office because it would impose a far higher maintenance cost on the hardware as well as safety and environmental problems.

The composition of the ink is traditionally comprised of an ion exchanged water, a water soluble organic solvent, and a colorant.

The inks used in the various ink-jet printers can be classified as either dye-based or pigment-based. A dye is a colorant which is molecularly dispersed or solvated by a carrier medium. The carrier medium can be a liquid or a solid at room temperature. A commonly used carrier medium is water or a mixture of water and organic co-solvents. All home and office inkjet printers use water-based inks while most industrial inkjet printers use solvent based inks.

Inks comprising various water-soluble dyes dissolved in aqueous media have been used. Several problems, however, are associated with soluble dyes that are not applicable to insoluble pigments. These problems include poor water-fastness, poor light fastness, poor thermal stability, facile oxidation, dye crystallization, and ink bleeding and feathering on the print medium. To circumvent these problems, use of a pigment as the colorant dispersed in aqueous media is preferred, even though not all the issued mentioned above will be satisfactory resolved even while using pigment based inks. Inks comprising pigments dispersed in aqueous media are advantageously superior to inks using water-soluble dyes in both water fastness and light fastness printed images. The use of a pigment in a water based ink composition poses a problem of dispersion stability. In this case, in order to stably disperse the pigment in an aqueous medium, polymeric dispersants, surfactants or the like are generally used as a dispersant. An ink using a pigment, the surface of which has been subjected to some treatment, for example, enhancing ejection stability, dispersion stability, print density and color development. The addition of a penetrating agent has been added to the ink composition to improve the penetration of ink into paper. For example, Japanese Patent Laid-Open No. 147861/1981 proposes the use of triethylene glycol monomethyl ether, Japanese Patent Laid-Open No. 111165/1997 proposes the use of ethers of ethylene glycol, or triethylene glycol.

In dye-based inks, no particles are observable under the microscope. Although there have been many recent advances in the art of dye-based ink-jet inks, such inks still suffer from deficiencies such as poor light fastness. When water is used as the carrier medium such inks also generally suffer from poor water-fastness.

An ink-jet image is formed when a precise pattern of dots is ejected from a drop-generating device known as a “print-head” onto a printing medium such as, for example, paper. When a recording is made on “plain paper”, the deposited colorants retain some mobility, which can produce poor bleed, edge acuity, feathering and inferior optical density (due to penetration into the paper used). These features adversely impact text and image quality.

The following conditions are generally required for inks utilized in ink-jet processes:
(1) the ink should possess liquid properties such as very low viscosity of the range of 2-8 cps, low surface tension (γ<40 mN/m)
(2) the ink should be able to be stored for long periods without causing clogging of print head orificies during use;
(3) the recording liquid should be quickly fixable onto recording media, such as, for example, paper, film or cloth such that the outlines of the resulting ink dots are smooth and there is minimal blotting of the dotted ink;
(4) the resultant ink image should be of high quality, such as having a clear color tone, high density, and high color gamut;
(5) the resultant ink image should exhibit excellent water-fastness (water resistance) and light fastness (light resistance);
(6) the ink should not chemically attack, corrode or erode surrounding materials such, for example, the ink storage container, print head components and orificies;
(7) the ink should not have an unpleasant odor and should not be toxic or inflammable; and
(8) the ink should exhibit low foaming and high pH stability characteristics.

Another problem encountered in using aqueous ink-jet ink compositions in thermal ink-jet printers is kogation. Sometimes, as ink in an ink-jet is heated at the ink chamber by the thermal element to be jetted, the ink will undergo thermal breakdown. This decomposition will lead to residue deposition on the resister's surface in a process known as “kogation”. Such deposits insulate the thermal heating of ink drops on the resister surface, thereby causing reduced bubble formation, decreased ejection velocity of the ink drops, and reduced drop volume delivered to the substrate. Consequently, print quality is reduced and failure in bubble formation may result in the failure of the ink-jet printer to print.

One important issue of ink-jet ink is the drying of the ink at the nozzle, which will cause either mis-directionality of the injected ink droplet or full clogging of the nozzle, leading to ‘missing nozzle’ and white strikes in the image. Drying at the nozzle is derived from fast evaporation of the ink carrier and is typical to water-based inks. To overcome this major issue, which badly affect both print quality and printer reliability, an extra component known as humectant is added to the ink: Humectants are water soluble organic solvents which possess a lower evaporation rate than water, thus slowing down the ink evaporation at the nozzle.

As already mentioned, ink-jet inks, which demonstrate very low viscosities, will tend to penetrate into the paper, causing two undesired phenomena, namely strike-through and feathering. Both phenomena will badly affect the optical density of the image and the edge sharpness, respectively. Furthermore the non-viscous inks will tend to demonstrate inter-color bleeding which is another negative effect on print quality.

Several methods have been developed to overcome these conflicting issues:

The most common method is the use of an ‘ink-jet substrate’ which contains a thin absorptive layer on top of the recording substrate which absorbs the ink droplet as soon as it touches the paper, eliminating any of the above mentioned negative effects on print quality. For example, U.S. Pat. No. 6,040,060 entitled “High Uniform Gloss Ink-Jet Receivers” to Missel et al, U.S. Pat. No. 6,534,156 entitled “Ink-Jet media Overcoat Layers” to Baker et al and U.S. Pat. No. 6,534,157 entitled “Ink-Jet Media” also to Baker et al discloses image recording elements for inkjet images.

A second method, often used in the industrial markets, is to use a heated substrate during printing, causing the ink to evaporate and, consequently, causing an increase in its viscosity. Once the viscosity of the ink on top of the substrate is high enough—none of the above mentioned print quality negative effects will occur. This technology is often used in the wide format printers produced, for example, by Scitex Vision and the Wide format printers produced by Nur Macroprinters Ltd.

A third method known in the state of the art, is where the ink is reacted with materials present on top to the printing substrate the result of the reaction being a freeze of the ink droplet.

One approach is reacting the anionic dye in the ink with polyvalent metal ions on top of the printing substrate, thus ‘fixing’ the dye to the substrate, thus eliminating any color bleeding, feathering or strike through. This approach is demonstrated for example, in U.S. Pat. No. 6,498,222 entitled “Water Resistance Imparter, Ink Composition, Reactive Fluid, and Method of Ink-Jet Recording with two fluids” to Kitamura et al. and U.S. Pat. No. 6,740,689 entitled “Ink and Underprinting Fluid combinations with improved Inkjet print Image Color and Stability” to Lee et al.

A different approach is adding a resin solution or a resin emulsion to the ink and a polyvalent metal cation on top of the printing substrate. For example U.S. Pat. No. 6,908,187 entitled “Ink-jet Recording Method” to Yoshizawa et al., the ink-jet method uses an aqueous ink containing fine resin particles, a water soluble dye and an organic solvent.

When the ink droplet hits the printing medium the polymer and the metal ion form a precipitate which eliminates ink bleeding, strike through and feathering.

Many different polymers have been used in the ink compositions.

Several metal ions or metal ions mixtures at different compositions have been claimed for being introduced into the printing medium. Poly cations (e.g. cationic polyelectrolytes) have also been introduced into the printing medium, to interact with the organic anionic polymers present in the ink. For example, U.S. Pat. No. 6,607,266 entitled “Liquid Composition, Ink for Ink-Jet, Ink Set for Ink-Jet Recording, Ink-Jet Recording Method, Recording Unit, Ink Cartridge, and Ink-jet recording Apparatus” to Hayashi discloses a liquid composition containing a polyvalent metal salt and the liquid composition which reacts with a color ink which provides an ink set for ink-jet recording. This approach, of adding anionic polymers to the ink, suffers from several drawbacks:

The required pH of the ink is high (for example acrylic polymers requires a pH higher than 8 to ensure solubility in the aqueous medium). This high pH can cause degradation of precipitation of several ink components.

Also the polymer can also interact with the coloring materials used in the ink, causing the precipitation of the reaction product.

Introducing polymers into the ink system typically increases the ink viscosity. All ink-jet print heads are limiting the ink viscosity and will not tolerate ink system with high viscosity.

The presence of polymer in the ink composition makes the printer much more susceptible to nozzle clogging once the ink carrier is evaporated.

### 3. SUMMARY OF THE INVENTION

The present invention over comes the limitations of the above mentioned methods by providing a two component system which comprises an aqueous ink-jet ink that contains, as one of the ingredients, an aqueous soluble salt that rapidly reacts with a substrate containing a soluble salt present in the fixation layer that lies on top of the substrate to form an insoluble reaction product which eliminates any further spreading of the ink droplets.

### 4. DETAILED DESCRIPTION OF THE PREFERRED EMBODIMENTS

The ink composition according to the present invention can produce high quality prints having good drying properties and free from feathering or bleeding, can be evenly printed on the surface of the recording media, and can realize high optical density.

The water-based ink-jet ink of the present invention is composed of a liquid vehicle, a wetting agent, a colorant and a water soluble salt.

The liquid vehicle comprises water with a co-solvent. In embodiments, it is preferred that the co-solvent is a water miscible organic component. Examples of suitable co-solvents include, but are not limited to, ethylene glycol, propylene glycol, diethylene glycol, glycerine, dipropylene glycols, polyethylene glycols, polypropylene glycols, aliphatic and aromatic amides, carboxylic acids, ethers, esters, alcohols, organosulfides, organosulfoxides sulfones such as for example sulfolane, derivatives of alcohols and ethers, carbitol, butyl carbitol, cellusolve, amino alcohols, ketones, N-methylpyrrolidone, cyclohexylpyrrolidone, hydroxyethers, lactones, imidazole derivatives, mixtures thereof and the like.

When mixtures of water and one or more co-solvents are selected as the liquid vehicle, the ratio of water to co-solvent may be in any effective range. Typically the ratio of water to co-solvent is from about 100:0 to about 30:70, preferably from about 97:3 to about 50:50, although the ratio can be outside these ranges. The non-water component of the liquid vehicle, when present, generally serves as a humectant and or curl additive, or a dye solubilizer, which typically has a boiling point higher than that of water.

The colorant for use in the ink compositions of the present invention may be selected from any suitable water-soluble dye or water-dispersible pigment or a combination thereof. The colorant may be present with or without a dispersing agent. The average particle size of the pigment colorant is preferably not more than 25 μm, more preferably not more than 1 μm. When the colorant is a pigment, inorganic or organic pigments are usable as the pigment without particular limitation. The pigment may be black, cyan, magenta, yellow, red, blue, green, brown, mixtures thereof, and the like. Examples of inorganic pigments usable herein include, in addition to titanium oxide, and iron oxide, carbon blacks. Examples of organic pigments usable herein include azo pigments such as for example, azo lake, polycyclic pigments such as for example phthalocyanine, perylene, anthraquinone, and dioxazine, nitro pigments, nitroso pigments and aniline black. Suitable organic commercial pigments include for example but not limited to, Black pigment (sold under the trade name of Hostafine Black TS by Clariant GmbH), Magenta pigment (sold under the trade name of Hostafine Rubin F6B by Clariant GmbH), Cyan pigment (sold under the trade name of Hostafine Blue B2G by Clariant GmbH), Yellow pigment (sold under the trade name of Hostafine Yellow GR by Clariant GmbH), Black pigment (sold under the trade name of Cabot 8247-7 by Cabot), Black pigment (sold under the trade name of Idis 15 by Degussa), Black pigment (sold under the trade name of Bayscript black VPSP 20016), Yellow pigment (sold under the trade name of Bayscript yellow VPSP 20017), Magenta pigment (sold under the trade name of Bayscript Magenta VPSP 20015) and Cyan pigment (sold under the trade name of Bayscript Cyan VPSP 25033).

As the coloring dye material, direct dyes, acidic dyes, basic dyes, dispersion dyes are mentioned and it is preferable that even when the coloring material is dissolved with the water-soluble salt, it does not react and solubility is maintained. Suitable coloring materials include, for example but not limited to, cyan dye (sold under the trade name of Bayscript Cyan BA), Yellow Dye (sold under the trade name Bayscript Yellow BR), Black Dye (sold under the trade name of Bayscript Black N liq. 01), Magenta Dye (sold under the trade name of Bayscript Magenta VPSP 24032).

Examples of suitable salts include, but not limited to, ammonium oxalate; sodium dodecyl sulphate; sodium carbonate; sodium fluoride; sodium sulfite; sodium hydrogen phosphate; sodium silicate; ammonium fluoride and any other salt which will cause an insoluble precipitation once it reacts with the salt present in the fixation layer.

Humectants may also be added to the inks of the present invention to prevent water evaporation and pigment sedimentation. Additionally, certain humectants such as N-methyl-pyrrolidone and 2-pyrrolidone have been found to improve dye solubility in the ink and thus serve the dual role as humectant and co-solvent.

As the water contained in the ink composition of the present invention, ion exchanged water, distilled water, pure water or ultrapure water may be used.

The term “wetting agent” as used herein is meant to indicate an agent for allowing the ink to uniformly wet on top of the substrate with no clusters, pin-holes or other un-wanted effects which are caused by bad wetting of the ink on top of the substrate.

Any aqueous commercially available wetting agent can be used if it provides the above characteristics to the ink used.

Suitable wetting agents include, for example but not limited to BYK-345 surfactant sold by BYK Chemie; BYK-307 wetting agent sold by BYK Chemie; BYK-306 surfactant sold by BYK Chemie; BYK-307 surfactant sold by BYK Chemie; BYK-308 surfactant sold by BYK Chemie; BYK-333 surfactant sold by BYK Chemie; BYK-341 surfactant sold by BYK Chemie; Fluorad FC-120 (or equivalent) Fluoro surfactant; Masurf FS-1620 surfactant sold by Mason Chemical Company; Surfinol 104 PG surfactant sold by Air Products; Dynol 604 surfactant sold by Air Products; Silwet L77 surfactant sold by Witco Chemicals.

The amount of the wetting agent added is preferably in the range of from 0.1 to 20% by weight, more preferably in the range of from 0.3 to 10% by weight, based on the ink. In preparing the ink-jet ink compositions, certain physical properties should be satisfied. For example, ink compositions for use in ink-jet recording processes should have appropriate viscosity and surface tension characteristics. It is preferred that the ink-jet composition of the present invention has a viscosity of from about 1.2 to about 6 cPs at 25° C. More preferably, the viscosity is from about 1.5 to about 3.0 cPs. It is also preferred that the ink-jet composition has a surface tension of from about 20-55 mN/m at 25° C. More preferably, the surface tension is from about 28-50 mN/m, and even more preferably from about 33-50 mN/m.

In preparing the fixation layer on top of the substrate any water soluble salt can be used as long as it will react instantaneously with the counter-salt which is present in the ink and form an insoluble precipitation.

Examples of suitable salts include, but not limited to calcium chloride; calcium acetate; copper (II) chloride; Ferric chloride; magnesium chloride; magnesium acetate; magnesium nitrate; zinc nitrate; aluminum sulfate and any other salt which will cause an insoluble precipitation once it reacts with the salt present in the water based ink.

Suitable wetting agents are used together with the salt solution to ensure uniform wetting of the fixation layer over the substrate used.

Preparation of the fixation layer is carried out by dissolving a suitable salt or combination of salts in aqueous solution and, optionally, adding wetting agents. A typical concentration of the aqueous solution can be 1-25%, more typically 5-15%.

It is also the object of this invention to provide a two-liquid system which will overcome the main limitations of the current state of the art: using a polymer as an additive to the ink and reacting it with poly valent metal ions in the substrate, suffers from three drawbacks:
(i) Polymer solution in the ink substantially increases the ink viscosity.
(ii) Polymer reaction with the metal ions in the fixation layer is diffusion controlled and Will be a relative slow reaction as compared to small ions reaction and diffusion in the ink solution.
(iii) There is a higher tendency to nozzle clogging.
   This is achieved by using a two-component printing system:

The ink which is jetted onto the substrate using ink-jet technology and an underlying layer which is present on the printed substrate prior to printing it with the ink (the fixation layer).

The ink and the fixation layer both contain chemical reactants which form a non-soluble precipitate once the two components are in contact that is when the ink droplet hits the fixation layer on top of the substrate.

While, in the past, such systems were using anionic polymers in the ink and metallic polyvalent cations in the underlying fixation layer, the present invention utilizes salts in both, the water based ink and the underlying layer.

The salts in both the ink and the fixation layer is composed of inorganic salts or the salts in the ink and in the fixation layer is composed of an organic anion and inorganic cation or the salts in the ink and in the fixation layer is composed of an organic cation and inorganic anion or the salts in the ink and in the fixation layer is composed of an organic anion and organic cation.

When the two salts which are present in the ink and in the fixation layer are mixed together a chemical reaction occurs, resulting in a rapid precipitation which is due to the fact that at least one of the cation-anion pairs of the salts present in the ink and in the fixation layer is a non-soluble salt.

Several examples are listed in the table below:

| | | Precipitated |
|---|---|---|
| Component in ink | Component in fixation layer | salt/salts |
| Inorganic cation & anion | | |
| NH₄F | CaCl₂ | CaF₂ |
| Na₂CO₃ | CaCl₂ | CaCO₃ |
| NH₄F | Mg(CH₃COO)₂ | MgF₂ |
| Salts of organic anions: | | |
| Sodium Oxalate | CaBr₂ | Calcium Oxalate |
| Sodium dodecyl sulfate | Al₂ (SO₄)₃ | Aluminum |
| | | dodecyl sulfate |

The non-soluble salt is precipitated instantaneously when the two reactants are mixed together, causing a fast freeze of the ink droplet.

This ink droplet will not spread any more to cause the un-wanted effects of feathering; bleeding; strike-through and optical density loss which are well known to the experts in the field.

Sometimes it is practical to use more than one set of reactants: Two or more salts might be added to the ink composition as well as to the fixation layer. In some cases, there is shown an improved effect and superior print quality.

Another option of this invention is to use the salts system in combination with a water-soluble anionic polymer in the ink, a polymer which will interact with the cation present in the fixation layer to form an insoluble precipitation once the ink hits the surface of the substrate.

The polymer might be any acrylic, methacrylic, styrene-acrylic copolymer or any other polymer which will form the above mentioned precipitation.

This combination can increase the rate of reaction of the system and reduce the amount of required polymer which, as a result will reduce the viscosity of the ink system.

The present invention will be described in more detail with reference to the following examples, though it is not limited to these examples only.

### 5. EXAMPLES

### Example 1

### Reference

An ink composition for an inkjet printer comprises of water, 18% ethylene glycol or 18% di-ethylene glycol, coloring material such as for example, a dye selected from 14% black dye solution (trade name Bayscript Black N liquid 01); 14% Magenta Dye solution (trade name Bayscript Magenta VPSP 25032); 14% Cyan Dye solution (trade name Bayscript Cyan BA) or 0.75% Yellow pigment powder (trade name Bayscript Yellow VPSP 20017); or a pigment selected from 5.2% Black pigment (trade name Hostafine Black TS manufactured by Clariant GmbH); 6.0% Magenta pigment (trade name Hostafine Rubin F6B manufactured by Clariant GmbH); 2.5% Yellow pigment (trade name Hostafine Yellow GR manufactured by Clariant GmbH).

A wetting agent consisting of 0.45% BYK 35 surfactant, 0.4% tri-ethanolamine, 2% N-methylpyrollidone and deionized water to balance the formulation to 100%. These ink compositions were used to print on top of a non-porous chromo paper as well as on a standard porous paper.

The inkjet printers used for printing was selected from the Epson Stylus C43SX and Epson Stylus C45.

The resulting print shows a lot of bleeding in-between the colors and poor overall print quality on the chromo non-porous coated paper and a lot of feathering and strike through on the porous paper.

### Example 2

To the specific ink composition of Example 1, which contained 14% black dye solution (trade name Bayscript Black N liquid 01), was added 5% (by weight) of sodium fluoride.

The paper substrates were coated with 10-30 microns of 10% aqueous magnesium chloride solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 3

To the specific ink composition of Example 1, which contained 14% black dye solution (trade name Bayscript Black N liquid 01), was added 5% (by weight) of sodium dodecyl sulfate.

The paper substrates were coated with 15 microns of 10% aqueous ferric chloride solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 4

To the specific ink composition of Example 1, which contained 14% black dye solution (trade name Bayscript Black N liquid 01), was added 5% (by weight) of sodium dihydrogen phosphate.

The paper substrates were coated with 15 microns of 10% aqueous calcium chloride solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 5

To the specific ink composition of Example 1, which contained 14% black dye solution (trade name Bayscript Black N liquid 01), was added 5% (by weight) of sodium sulfide.

The paper substrates were coated with 15 microns of 10% aqueous cupric chloride solution.

Printing with black ink only (due to the dark color of the cupric sulfide) demonstrated superior print quality with no bleeding.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 6

To the specific ink composition of Example 1, which contained 14% black dye solution (trade name Bayscript Black N liquid 01), was added 5% (by weight) of sodium carbonate.

The paper substrates were coated with 15 microns of 10% aqueous Ferric chloride solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 7

To the specific ink composition of Example 1, which contained 14% black dye solution (trade name Bayscript Black N liquid 01), was added 5% (by weight) of sodium sulfide.

The paper substrates were coated with 15 microns of 10% aqueous zinc nitrate solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 8

To the specific ink composition of Example 1, which contained 14% black dye solution (trade name Bayscript Black N liquid 01), 5% (by weight) of sodium carbonate.

The paper substrates were coated with 15 microns of 10% aqueous aluminum sulfate solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 9

To the specific ink composition of Example 1, which contained 14% black dye solution (trade name Bayscript Black N liquid 01), was added 2% (by weight) of sodium fluoride and 1.5% of Joncryl 8085 (a styrene acrylic resin solution; 43% solids in ammonia solution. Made by Johnson Polymers Ltd, The Netherlands) have been added

The paper substrates were coated with 15 microns of 10% aqueous calcium acetate solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 10

To the specific ink composition of Example 1, which contained 14% black dye solution (trade name Bayscript Black N liquid 01), was added 5% (by weight) of ammonium fluoride.

The paper substrates were coated with 10-30 microns of 10% aqueous magnesium acetate solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 11

To the specific ink composition of Example 1, which contained 14% black dye solution (trade name Bayscript Black N liquid 01), 5% (by weight) of ammonium fluoride. The paper substrates were coated with 10-30 microns of 10% aqueous zinc chloride solution.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 12

To the specific ink composition of Example 1, which contained 14% black dye solution (trade name Bayscript Black N liquid 01), was added 5% (by weight) of aqueous sodium silicate solution.

The paper substrates were coated with 15 microns of 10% aqueous solution of calcium chloride.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

### Example 13

To the specific ink composition of Example 1, which contained 14% black dye solution (trade name Bayscript Black N liquid 01), was added 5% (by weight) of an aqueous solution of sodium silicate.

The paper substrates were coated with 15 microns of a 10% aqueous solution of magnesium acetate.

Printing on a coated glossy paper under the same conditions as in Example 1 demonstrated superior print quality with no bleeding.

Repeating the same experiment on a porous paper demonstrated higher overall print quality than printing using the ink described in Example 1, with no feathering, higher optical density and less strike through.

While the foregoing invention has been described in some detail for purposes of clarity and understanding, it will be clear to one skilled in the art from reading of this disclosure of the invention that various changes in form and detail can be made without departing from the true scope of the invention.

What is claimed is:

1. An ink-jet recording method comprising the step of:
ejecting an aqueous ink-jet ink composition as a droplet onto a substrate coated printed material, defined as the fixation layer, causing a rapid reaction of the ink composition and substrate coated printing material to precipitate a non-soluble salt when the ink droplet hits the fixation layer on top of the substrate;
wherein the ink-jet ink composition comprises of:
(i) a colorant selected from a water soluble dye or a water dispersible pigment;
(ii) a water soluble organic solvent selected from a polyhydric alcohol, a polyhydric alcohol derivative, a nitrogen containing solvent, an aliphatic, cycloaliphatic or aromatic alcohol, a sulfur containing solvent;
(iii) water selected from ion exchanged water, distilled water, pure water or ultrapure water;
(iv) a wetting agent;
(v) a water soluble salt or salts and optionally
(vi) an anionic polymer resin
and the said substrate comprises one or more aqueous soluble salts and, optionally, wetting agents, present in the fixation layer on top of the printing material.

2. A method according to claim 1 wherein the printing material is selected from paper, cloth or film.

3. A method according to claim 1 wherein the water soluble dye is selected from a cyan dye, a yellow dye, a magenta dye and a black dye and a water dispersible pigment is selected from a black pigment, a magenta pigment, a cyan pigment and a yellow pigment.

4. A method according to claim 3 wherein the water soluble dye is selected from Bayscript Cyan BA, Bayscript Yellow BR, Bayscript Black N liq.01 and Bayscript Magenta VPSP 24032.

5. A method according to claim 3 wherein water dispersible pigment is selected from Hostafine Black TS, Hostafine Rubin F6B, Hostafine Blue B2G, Hostafine Yellow GR, Cabot 8247-7, Idis 15, Bayscript Black VPSP 20016, Bayscript Yellow VPSP 20017, Bayscript Magenta VPSP 20015 and Bayscript Cyan VPSP 25033.

6. A method according to claim 1 wherein the water soluble salts are selected from an inorganic salt, a salt produced from an anion of an organic compound and a cation of an inorganic compound, a salt produced from a cation of an organic compound and a anion of an inorganic compound, a salt produced from a cation of an organic compound and an anion of an organic compound.

7. A method according to claim 6 wherein the water soluble salts are selected from ammonium oxalate, sodium dodecyl sulfate, sodium carbonate, sodium fluoride, sodium sulfite, sodium hydrogen phosphate, sodium silicate and ammonium fluoride.

8. A method according to claim 1 wherein the anionic polymer is selected from an acrylic polymer; styrene-acrylic copolymer; methacrylic polymer; copolymer of styrene and maleic acid and their monoesters, homopolymers and copolymers derived from methacrylic acid and acrylic acid and their monoesters. Mixture of several of the above polymers.

9. A method according to claim 1 wherein the salts used in the fixation layer are selected from calcium chloride, calcium acetate, copper(II) chloride, ferric chloride, magnesium chloride, magnesium acetate, magnesium nitrate, zinc nitrate and aluminum sulfate.

10. A method according to claim 1 wherein the fixation layer consists of an aqueous composition is, incorporated onto the substrate during the printing process, or be introduced to the substrate prior and independent to the printing method or be introduced to the substrate during the substrate production, independently of the said method using any conventional coating method.

11. A method according to claim 10 wherein the fixation layer comprises of an aqueous composition that consists of soluble salts and, optionally, a wetting agent and said layer is introduced on top of the substrate.

12. An ink composition comprising
(i) a colorant selected from a water soluble dye or a water dispersible pigment,
(ii) a water soluble organic solvent selected from a polyhydric alcohol, a polyhydric alcohol derivative, a nitrogen containing solvent, an aliphatic, cycloaliphatic or aromatic alcohol, a sulfur containing solvent,
(iii) water selected from ion exchanged water, distilled water, pure water or ultrapure water,
(iv) a wetting agent,
(v) a water soluble salt or salts and optionally
(vi) an anionic polymer resin.

13. An ink composition according to claim 12 wherein the water soluble dye is selected from a cyan dye, a yellow dye, a magenta dye and a black dye and the water dispersible pigment is selected from a black pigment, a magenta pigment, a cyan pigment and a yellow pigment.

14. An ink composition according to claim 13 wherein the water soluble dye is selected from Bayscript Cyan BA, Bayscript Yellow BR, Bayscript Black N liq.01 and Bayscript Magenta VPSP 24032.

15. An ink composition according to claim 13 wherein the water dispersible pigment is selected from Hostafine Black TS, Hostafine Rubin F6B, Hostafine Blue B2G, Hostafine Yellow GR, Cabot 8247-7, Idis 15, Bayscript Black VPSP 20016, Bayscript Yellow VPSP 20017, Bayscript Magenta VPSP 20015 and Bayscript Cyan VPSP 25033.

16. An ink composition according to claim 12 wherein the water soluble salts are selected from an inorganic salt, a salt produced from an anion of an organic compound and a cation of an inorganic compound, a salt produced from a cation of an organic compound and a anion of an inorganic compound, a salt produced from a cation of an organic compound and an anion of an organic compound.

17. An ink composition according to claim 16 wherein the water soluble salts are selected from ammonium oxalate, sodium dodecyl sulfate, sodium carbonate, sodium fluoride, sodium sulfite, sodium hydrogen phosphate, sodium silicate and ammonium fluoride.

18. An ink composition according to claim 12 wherein the anionic polymer is selected from an acrylic polymer; styrene-acrylic copolymer; methacrylic polymer; copolymer of styrene and maleic acid and their monoesters, homopolymers and copolymers derived from methacrylic acid and acrylic acid and their monoesters and mixtures of the above.

19. A fixation layer composition comprises of water-soluble salts which, upon reaction with the ink droplet of claim 10 produces a water insoluble precipitate.

20. A fixation layer composition according to claim 19 wherein the water soluble salt is selected from magnesium chloride; ferric chloride; calcium chloride; cupric chloride; zinc nitrate; aluminum nitrate; calcium acetate; magnesium acetate and zinc chloride.
